(19) United States
(12) Patent Application Publication
(10) Pub. No.: US 2026/0054221 A1
(43) Pub. Date: Feb. 26, 2026

(54) INTEGRATED DESALINATION ENERGY RECOVERY MODULE

(71) Applicant: Flowserve Pte. Ltd., Singapore (SG)

(72) Inventors: Ramakrishnan Rengasamy, Fogelsville, PA (US); Victor Alberto Ruiz Martinez, Albacete (ES); Francesco Giuseppe Ladisa, Madrid (ES)

(73) Assignee: Flowserve Pte. Ltd., Singapore (SG)

(21) Appl. No.: 18/814,835

(22) Filed: Aug. 26, 2024

(51) Int. Cl. B01D 61/06; B01D 61/02; B01D 61/08; C02F 1/44; C02F 103/08; F03G 3/00; F04D 13/06

(52) U.S. Cl. CPC B01D 61/06; B01D 61/025; B01D 61/08; C02F 1/441; F03G 3/096; F04D 13/06; B01D 2313/243; B01D 2313/246; C02F 2103/08; C02F 2303/10

(57) ABSTRACT

A compact, low footprint energy recovery module for a reverse osmosis (RO) desalination system comprises a vertical stack of horizontal conduits, at least one energy recovery device (ERD), and an axial integral motor pump (IMP). The horizontal conduits are configured to carry low-pressure brackish water, pressurized brackish water, high pressure brine, and low-pressure brine. The ERDs, which are substantially cylindrical and vertically oriented, are interconnected with the horizontal conduits and entirely supported thereby. The IMP is substantially cylindrical and extends horizontally and coaxially from an outlet end of the pressurized water conduit, the IMP being configured to further pressurize the pressurized water for input to a membrane osmosis device. The IMP can have a diameter that exceeds a largest horizontal conduit diameter by no more than 25%. The IMP can be driven by a variable frequency controller, being thereby continuously variable in pumping speed.

### FIELD OF THE INVENTION

The invention relates to water desalination systems, and more particularly, to energy recovery from membrane osmosis devices included in desalination systems.

### BACKGROUND OF THE INVENTION

There are many locations throughout the world where seawater is plentiful, but fresh water is scarce. One approach to meeting agricultural needs and other demands for fresh water in these regions is to desalinate water to produce fresh water. However, these applications can be financially prohibitive due to high operating costs, with energy being the primary cost driver in any desalination process.

Reverse osmosis (RO) is the most common approach to desalinating seawater and brackish water, because it is generally more energy efficient than other methods. According to this approach, the water is pressurized and directed to a membrane osmosis device (MO device), within which fresh water is separated from pressurized brine by one or more membranes. An energy recovery system is typically used in RO desalination applications to further reduce energy consumption by recovering some of the energy that is expended in pressurizing the high-pressure brine.

It will be noted that, unless otherwise stated or required by context, the terms “seawater,” “brackish water,” and simply “water” are used herein generically to refer to any water that is to be desalinated, which can includes both actual seawater, which contains more than 35,000 milligrams per liter (mg/l) of total dissolved solids (TDS), as well as brackish water that contains between 1,000 and 10,000 mg/l of TDS, making it less salty than seawater but still too salty to drink. The term “brine” is used herein to refer to water that is produced as a by-product of the desalination process, which contains more than 10,000 mg/l of TDS, and may also contain dissolved minerals and other contaminants that are removed from the seawater during desalination. Water having substantially no salt content is referred to herein as “fresh” water.

A simplified block diagram of an RO system is presented in FIG. 1. In the illustrated system, filtered seawater or other brackish water 110 (sometimes referred to herein simply as “water”) is converted into first and second portions of low-pressure water 110a, 110b by a low-pressure feed pump 100. The first portion 110a of the low-pressure water is directed to a high-pressure feed pump 102, which converts the first portion of low-pressure water 110a into a first portion 104a of high-pressure water, the high-pressure water 104 being directed to the input of a membrane osmosis device (MO device) 106. The MO device 106 contains one or more membranes that allow only fresh water 108 to pass through, while the remaining, “rejected” high-pressure brine 112 is continuously removed from the MO device 106.

In the system of FIG. 1, the remainder of the low-pressure water is directed as a “second portion” of the low-pressure water 110b to an inlet of, and an ERD booster pump 126. The second portion of low-pressure water 100 flows to an inlet of a pressurizing loop 118 that is included in an energy recovery device (ERD) 116, while the high-pressure brine 112 from the MO device 106 flows to an inlet of a drive loop 120 of the ERD 116. The two loops 118, 120 of the ERD 116 are mechanically coupled with each other, such that some of the pressure of the brine 112 is transferred to the seawater 110. As a result, relatively low-pressure brine 122 flows out from the outlet of the drive loop 120 while medium pressure water (“pressurized water”) 124 flows out of the outlet of the pressurizing loop 118.

The pressurized water 124 is then transformed by an ERD booster pump 126 into a second portion of high-pressure water 104b, which is combined with the first portion of high-pressure water 104a to form the high-pressure water 104 that is directed to the MO device 106. The additional energy requirement of the ERD booster pump 126 is less than the energy savings that are realized by the high-pressure feed pump 102, such that overall energy consumption is reduced.

Most existing RO systems, such as the one illustrated in FIG. 1, are complex, costly to manufacture, difficult to transport, and have a very large installed footprint. Generally, separate manufacture, delivery and installation of many different elements is required, including the ROs devices 106, the ERDs 116, the conventional booster and circulation pumps 100, 102, and the connecting pipes, and other accessories 114. Depending on the RO system requirements it is often necessary to design a custom energy recovery system for each installation, according to the number and capacities of the included MO devices 106. Depending on the requirements of the MO devices 106, a plurality of ERDs 116 may be needed, each with its associated pipes 114 and booster pumps 128.

The implementation of RO systems has therefore been limited mainly to large scale installations that serve markets requiring high desalination capacities, so that the high cost and large footprint can be justified.

Accordingly, there is a need for a more “modular” RO desalination system architecture that reduces the number of elements that must be separately designed, manufactured, shipped, and assembled onsite, as well as reducing the footprint of the installed system. In particular, there is a need for an RO energy recovery system having a reduced number of elements that must be separately transported and assembled onsite, and a reduced footprint.

### SUMMARY OF THE INVENTION

The present invention is a modular RO energy recovery system that can be transported as a single unit, has a minimal footprint, and does not require onsite installation and interconnection of separate elements.

The disclosed RO energy recovery module comprises one or more ERDs that are compact and, in embodiments, substantially cylindrical in shape. The ERDs are arranged vertically in a horizontal row, with their inlets and outlets connected in parallel to four horizontal conduits that are spaced apart and vertically stacked, the ERDs being thereby fixed to, and entirely supported by, the horizontal conduits.

Rather than providing a separate ERD booster pump and motor with associated hoses and interconnections, the disclosed energy recovery module includes a compact integral motor pump (IMP) that combines both an axial drive motor and a turbo-pump within a common housing. The axial IMP is substantially cylindrical in shape, and is sufficiently compact in diameter to be nested within the vertical stack of horizontal conduits and pre-installed in-line with the pressurizing loop outlet conduit of the ERD without any intervening hoses. Accordingly, the ERD booster pump is an axial IMP that is integral to the energy recovery module, does not increase the module footprint, and does not require onsite interconnection with the ERD.

In the disclosed RO energy recovery module the ERDs, the ERD booster pump, and all required interconnections are combined into a unitary element that has a minimal footprint, and requires only input, output, and electrical interconnection onsite.

One general aspect of the present invention is a reverse osmosis (RO) energy recovery module suitable for recovering pressure energy from a membrane osmosis device (MO device). The RO energy recovery module includes an energy recovery device (ERD) configured to transfer pressure from a high-pressure brine output of the MO device to low-pressure water, thereby producing pressurized water, the ERD comprising a high-pressure brine inlet, a pressurized water outlet, a low-pressure water inlet, and a low-pressure brine outlet, said inputs and outputs being vertically arranged, a vertical stack of horizontal conduits arranged proximate the ERD, the vertical stack of horizontal conduits comprising a low-pressure water conduit, a pressurized water conduit, a high-pressure brine conduit, and a low-pressure brine conduit, each of the horizontal conduits being fixed to and in fluid communication with a corresponding one of the ERD inputs and outputs, the ERD being entirely supported by the horizontal conduits, and an integral motor pump (IMP) extending from and directly fixed to a horizontal outlet end of the pressurized water conduit, the IMP being configured to transform pressurize water flowing out from the pressurized conduit into high-pressure water that is suitable for input into the MO device. The IMP is directly coupled to the pressurized water conduit and coaxial therewith, the IMP being vertically nested between a first of the horizontal conduits that is directly above the pressurized water conduit and a second of the horizontal conduits that is directly below the pressurized water conduit.

In embodiments, the ERD is a first ERD of a plurality of substantially identical ERDS having inputs and outputs that are fixed to and in fluid communication with the horizontal conduits. In some of these embodiments, the first ERD is located on a first lateral side of the vertical stack of horizontal conduits, and wherein a second ERD of the plurality of ERDs is located on an opposing, second lateral side of the vertical stack of horizontal conduits.

In any of the above embodiments, the ERD can comprise a substantially cylindrical vertical body. In some of these embodiments, the ERD further comprises a drum that is coaxial with the cylindrical body and rotatable therein, and first and second ducts fixed within the drum on opposing sides thereof, where rotation of the drum causes the first and second ducts to alternately and concurrently form fluid connections between the high-pressure brine inlet and the pressurized water outlet, and between the low-pressure water inlet and the low-pressure brine outlet, thereby filling the first duct with high-pressure brine while water contained within the first duct is pressurized and forced out of the first duct through the pressurized water outlet, while the second duct is filled with low-pressure water while low-pressure brine contained within the second duct is forced out of the second duct through the low-pressure brine outlet.

In any of the above embodiments, the IMP can be vertically nested between the low-pressure water conduit and the high-pressure brine conduit.

In any of the above embodiments, the IMP can be substantially cylindrical, having a diameter that does not exceed a largest diameter of the horizontal conduits by more than 25%.

In any of the above embodiments, the IMP can be substantially cylindrical about an IMP axis, the IMP comprising an impeller configured to rotate about the IMP axis, a plurality of permanent magnets fixed to a rear side of the impeller and configured to pass in close axial proximity to a corresponding plurality of stator coil assemblies as the impeller rotates, the permanent magnets and stator coil assemblies in combination forming an integral, axial motor that drives the impeller. In some of these embodiments, the stator coil assemblies are energized by a variable frequency drive.

In any of the above embodiments, the IMP can comprise a plurality of IMP modules directly interconnected horizontally and coaxially in series, all of which are vertically nested between the first horizontal conduit and the second horizontal conduit.

In any of the above embodiments, the IMP can comprise a plurality of IMP modules interconnected in parallel and extending horizontally from the pressurized water conduit between the first horizontal conduit and the second horizontal conduit.

A second general aspect of the present invention is a reverse osmosis water desalination system (RO system). The RO system includes a low-pressure feed pump configured to direct low pressure water into the RO system, a membrane osmosis device (MO device) configured to separate high-pressure water into fresh water and high-pressure brine, a high-pressure feed pump configured to convert a first portion of the low-pressure water into a first portion of the high-pressure water, an RO energy recovery module according to the first general aspect, the RO energy recovery module being configured to receive the high-pressure brine, and to convert a second portion of the low-pressure water, into a second portion of the high-pressure water, the combined first and second portions of the high-pressure water being the high-pressure water that is separated by the MO device into the fresh water and the high-pressure brine.

In embodiments, the ERD is a first ERD of a plurality of substantially identical ERDS having inputs and outputs that are fixed to and in fluid communication with the horizontal conduits. In some of these embodiments, the first ERD is located on a first lateral side of the vertical stack of horizontal conduits, and wherein a second ERD of the plurality of ERDs is located on an opposing, second lateral side of the vertical stack of horizontal conduits.

In any of the above embodiments, the IMP can be vertically nested between the low-pressure water conduit and the high-pressure brine conduit.

In any of the above embodiments, the IMP can be substantially cylindrical, having a diameter that does not exceed a largest diameter of the horizontal conduits by more than 25%.

In any of the above embodiments, the IMP can be substantially cylindrical about an IMP axis, and can include an impeller configured to rotate about the IMP axis, a plurality of permanent magnets fixed to a rear side of the impeller and configured to pass in close axial proximity to a corresponding plurality of stator coil assemblies as the impeller rotates, the permanent magnets and stator coil assemblies in combination forming an integral, axial motor that drives the impeller. In some of these embodiments, the stator coil assemblies are energized by a variable frequency drive.

In any of the above embodiments, the IMP can include a plurality of IMP modules directly interconnected in series, all of which are vertically nested between the first horizontal conduit and the second horizontal conduit.

And in any of the above embodiments, the RO system can include a plurality of RO energy recovery modules according to the first general aspect, the RO energy recovery modules being aligned in a horizontal row, axial inlets of the low-pressure water conduits, axial outlets of the IMPs, axial inlets of the high-pressure brine conduits, and axial outputs of the low-pressure brine conduits being vertically spaced apart and horizontally aligned and interconnected respectively by a low pressure water manifold, an IMP manifold, a high-pressure brine manifold, and a low pressure brine manifold.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a block diagram that illustrates the structure of a reverse osmosis desalination system of the prior art;

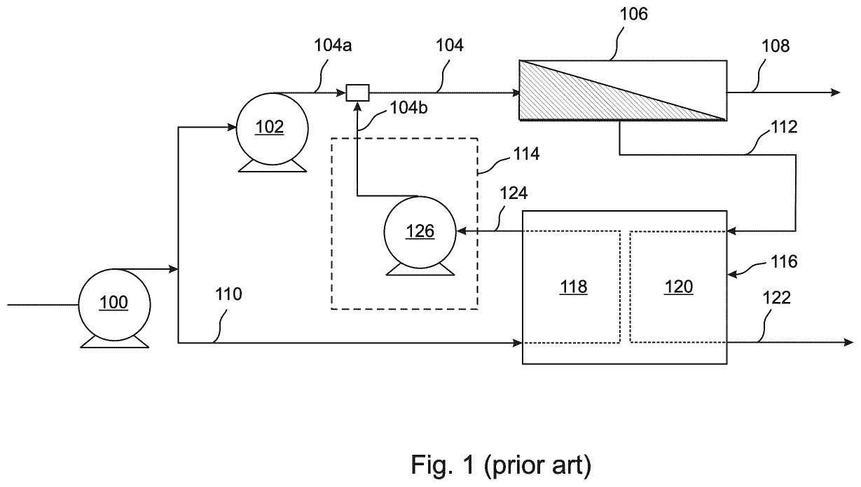

FIG. 2A is a block diagram that illustrates the structure of a reverse osmosis desalination system that implements the energy recovery module of the present invention;

FIG. 2B is a cross-sectional side view, drawn to scale, of an energy recovery device in an embodiment of the present invention;

FIG. 3A is a side view, drawn to scale, of an embodiment of the present invention;

FIG. 3B is a perspective view, drawn to scale, of the embodiment of FIG. 3A;

FIG. 4 is a cross-sectional side view, drawn to scale, of an IMP in an embodiment of the present invention;

FIG. 5A is a side view, drawn to scale, of an embodiment of the present invention that is similar to FIG. 3A but includes two IMPs in series;

FIG. 5B is an end view, drawn to scale, of an embodiment of the present invention that is similar to FIG. 3A but includes two IMPs in parallel; and

FIG. 6 is a perspective view of an embodiment of the present invention that includes three RO energy recovery modules interconnected by manifolds according to an embodiment of the present invention, the drawing being to drawn scale except for the manifolds.

### DETAILED DESCRIPTION

The present invention is an integrated, modular RO energy recovery system that can be transported as a single module, has a minimal footprint, and does not require onsite installation and/or interconnection of separate elements.

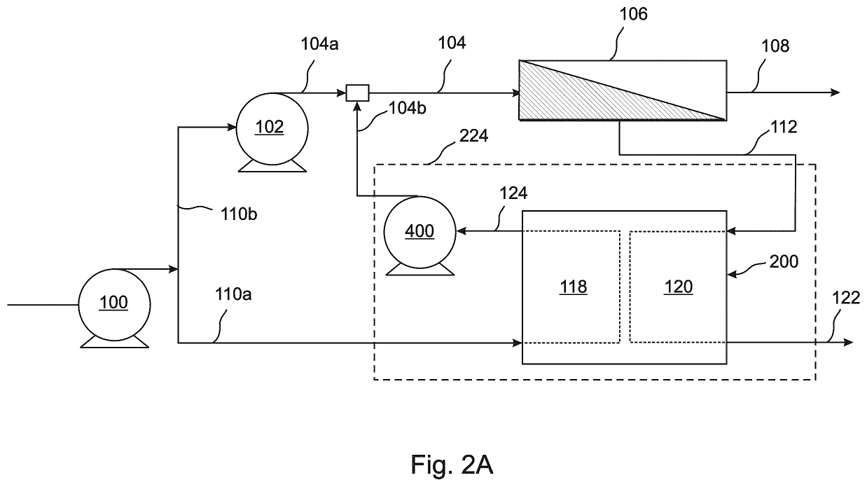

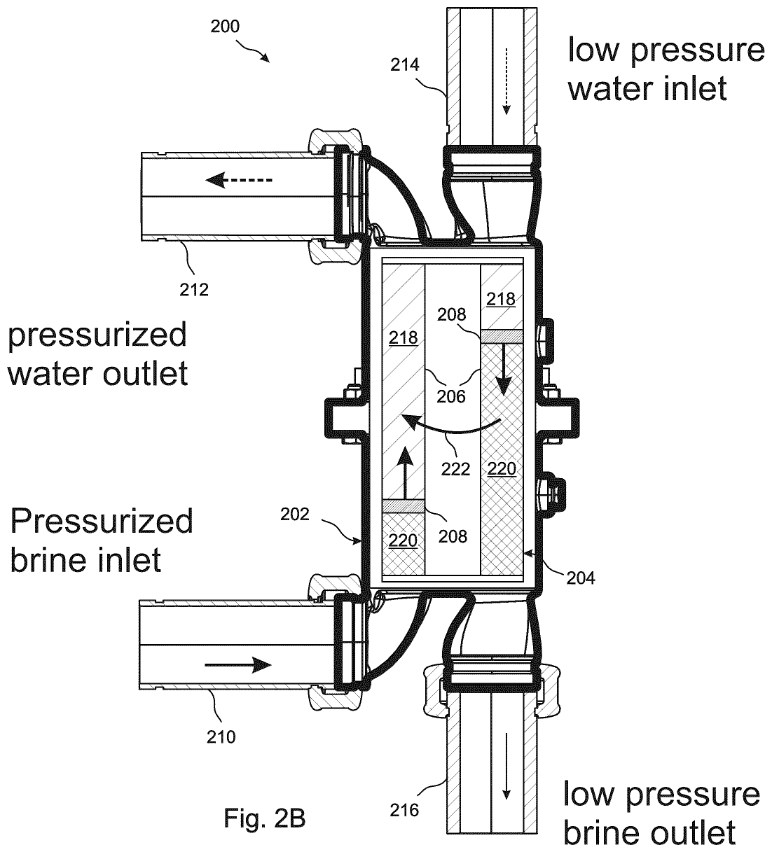

With reference to FIG. 2A, the disclosed RO energy recovery system 224 is an energy recovery module comprising one or more ERDs 200 that are compact and substantially cylindrical in shape.

FIG. 2B presents a cross-sectional side view of an ERD 200 that is included in embodiments of the present invention. In the illustrated embodiment, the ERD 200 includes a substantially cylindrical body 202 surrounding a rotatable drum 204. The drum 204 includes at least two ducts 206 mounted thereto.

A high-pressure brine inlet 210 and a pressurized water outlet 212 extend horizontally proximate opposing ends of the cylindrical body 202, while a water inlet 214 and a low-pressure brine outlet 216 extend longitudinally from the opposing ends of the cylindrical body 202.

As the drum 204 rotates 222 within the cylindrical body 202, the ducts 206 are alternately connected between the high-pressure brine inlet 210 and pressurized water outlet 212, and between the water inlet 214 and a low-pressure brine outlet 216. When a duct 206 is connected between the water inlet 214 and a low-pressure brine outlet 216, the duct 206 is filled via the water inlet 214 with seawater 218 that has been pressurized by a feed pump 100, thereby expelling low-pressure brine 220 through the brine outlet 216. Due to the pressures of the fluids and the high rotation rate of the drum 204 (over 800 rpm in embodiments), any mixing 208 between the seawater 218 and the low-pressure brine 220 within the duct 206 is minimal.

Subsequently, the drum 204 is rotated 222 until the duct 206 is connected between the brine inlet 210 and water outlet 212, where high-pressure brine from the MO device 106 flows through the brine inlet 210 and fills the duct 206, pressurizing the seawater 218 as it is expelled through the water outlet 212. The brine thereby expends energy while pressurizing the seawater 218, and becomes low-pressure brine 220.

The drum 204 rotates 222 continuously under the impetus of the flowing seawater 218. While only two ducts 206 are shown in the figure, embodiments include a larger number of adjacent ducts 206 that are arranged circumferentially adjacent to each other and successively placed into alignment with the inlets 210, 214 and outlets 212, 216, thereby providing nearly continuous flows of brackish water, fresh water, and brine through the ERD 200.

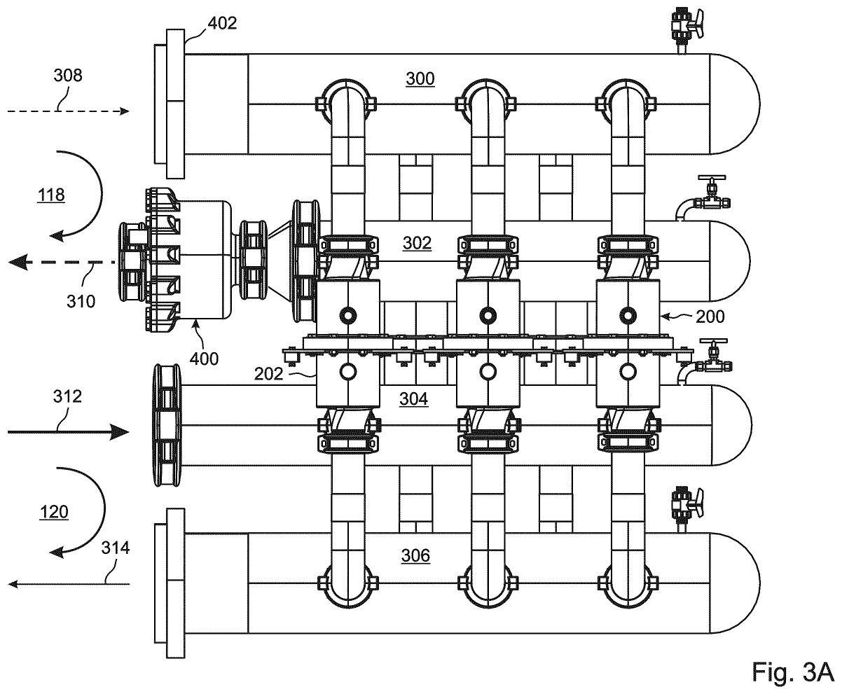

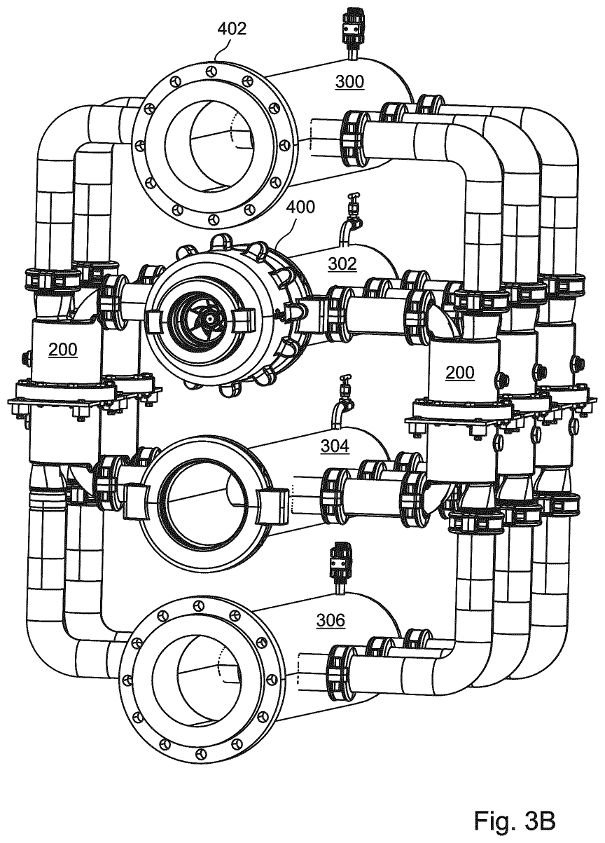

With reference to the side view of FIG. 3A, in the disclosed RO energy recovery module the ERDs 200 are arranged vertically in a horizontal row, with their inlets and outlets connected in parallel to four horizontal conduits 300, 302, 304, 306 that are spaced apart and vertically stacked, the ERDs 200 being thereby fixed to, and entirely supported by, the horizontal conduits 300, 302, 304, 306. These include a low-pressure water inlet conduit 300, a pressurized water outlet conduit 302, a high-pressure brine inlet conduit 304 and a low-pressure brine outlet conduit 306. Low pressure water 308 flowing into the low-pressure water inlet conduit 300 and pressurized water 310 flowing out from the pressurized water outlet conduit 302 form the pressurizing loop 118, while high pressure brine 312 flowing into the high-pressure brine inlet conduit 304 and low-pressure brine 314 flowing out from the low-pressure brine outlet conduit 306 form the drive 120 loop.

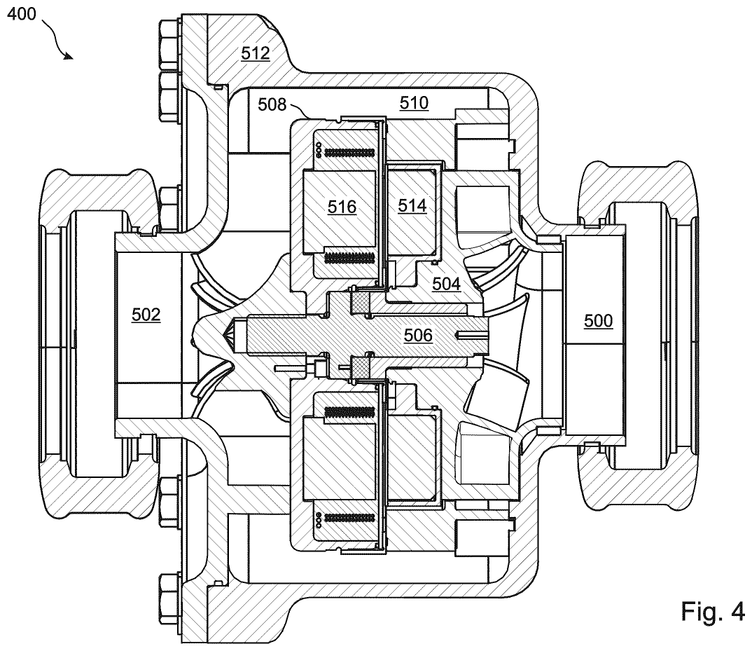

With reference to the perspective view of FIG. 3B, ERDs 200 can be included on either or both sides of the horizontal conduits 300, 302, 304, 306. The footprint of the assembly is therefore determined by the lengths of the horizontal conduits 300, 302, 304, 306 and the latitudinal separations between the ERDs 200 and the horizontal conduits 300, 302, 304, 306 if the ERDs are located on only one side of the horizontal conduits 300, 302, 304, 306, or on the separations between the opposing ERDs 200 if ERDs 200 are included on both sides of the horizontal conduits 300, 302, 304, 306. FIG. 4B three ERDs 200 are included on one side of the vertical stack of horizontal conduits 300, 302, 304, 306, and two ERDs 200 are included on the other side of the vertical stack of horizontal conduits 300, 302, 304, 306, thereby including five ERDs 200 in total. It will be clear that other embodiments include only one ERD 200, only two ERDs 200, or any other desired number of ERDs 200 on either or both sides of the vertical stack of horizontal conduits 300, 302, 304, 306.

With reference again to FIG. 3A, rather than providing a separate ERD booster pump 126 with associated hoses and interconnections, the disclosed energy recovery module includes a compact integral motor pump (IMP) 400 that combines both an axial drive motor and a turbo-pump within a common housing. The IMP 400 is substantially cylindrical in shape, and is sufficiently compact in diameter to be pre-installed in-line with the pressurized water outlet conduit 302 of the ERD 200 and nested within the vertical stack of horizontal conduits between two other horizontal conduits, which in FIGS. 3A and 3B are the low-pressure water inlet conduit 300 and the high-pressure brine inlet conduit 304.

It can also be seen in FIG. 3A that the length of the pressurized water outlet conduit 302 is reduced, such that the combined length of the pressurized water outlet conduit 302 and the IMP 400 is substantially equal to the lengths of the other three horizontal conduits 300, 304, 306.

In the illustrated embodiment, the diameter of the IMP 400 is approximately equal to the diameter of the connecting flange 402 of the low-pressure water inlet conduit 300. In embodiments, the diameter of the IMP 400 exceeds the largest diameter of the horizontal conduits 300 by no more than 25%.

It is clear, therefore, that the axial IMP 400 is an integral part of the disclosed RO energy recovery module, and does not increase the footprint of the module beyond what is already required by the horizontal conduits 300, 302, 304, 306 and the ERDs 200. Also, it is clear that the IMP does not require separate transportation and onsite installation, but is delivered to the installation site already interconnected with, and integral to, the energy recovery module.

The disclosed RO energy recovery module therefore combines the ERDs 200, the ERD booster pump (IMP 400), and all required interconnections into a unitary module that has a minimal footprint, reduced pressure loss, and requires only input, output, and electrical interconnection onsite.

FIG. 4 is a cross-sectional side view of an IMP 400 in an embodiment of the invention. In the illustrate embodiment, the IMP 400 comprises an inlet 500 and an outlet 502 located in axial alignment on opposite ends of the IMP 400. pressurized water flows through the inlet 500 to an impeller 504 that rotates about a fixed shaft 506 that is substantially colinear with a central axis of the IMP 400. The impeller 504 propels the pressurized water axially past a stator housing 508 through an annular flow passage 510 formed between the stator housing 508 and the pump housing 512.

A plurality of permanent magnets 514 are attached to the back of the impeller 504, and pass in close axial proximity to a corresponding plurality of stator coil assemblies 516 as the impeller 504 rotates. In combination, the permanent magnets 514 and stator coil assemblies 516 form an integral motor that drives the impeller 504. In embodiments, the stator coil assemblies 516 are energized by a variable speed controller, such as a variable frequency drive (“VFD”), thereby enabling control of the impeller rotation rate over a continuous range of speeds.

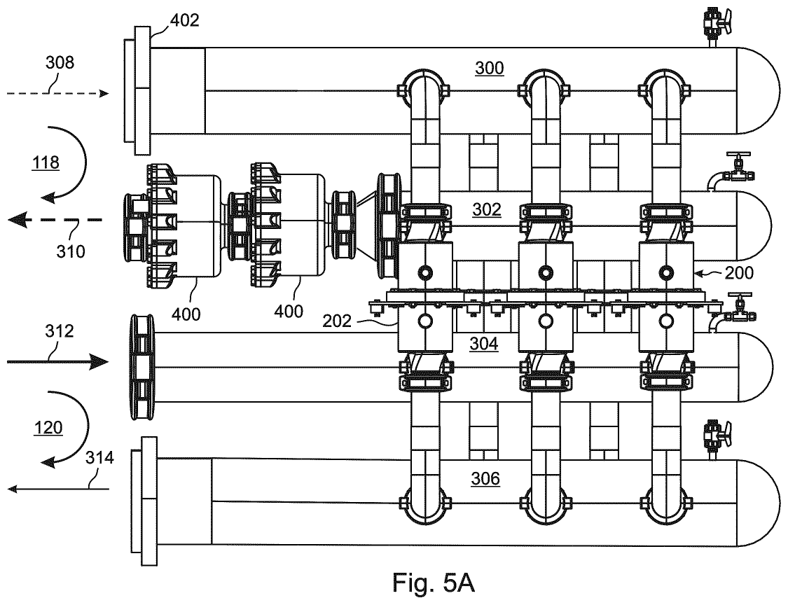

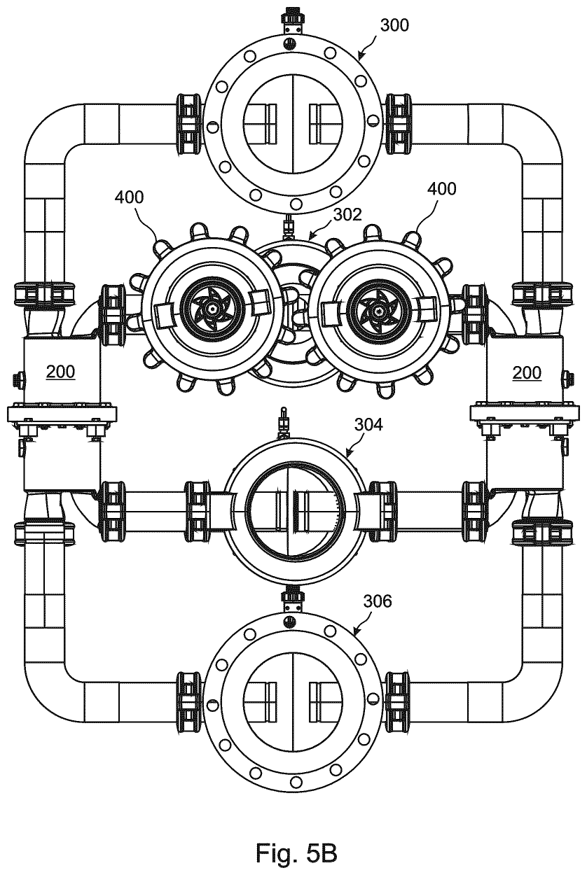

With reference to FIG. 5A, in the illustrated embodiment the IMP 400 is modular, such that a plurality of IMPs 400 can be directly interconnected in series and included as an assembly of IMPs in the energy recovery module, in place of the single IMP 400 of FIG. 4. FIG. 5A is a side view of an embodiment similar to FIG. 4A, but including two IMPs 400 assembled in series, in place of the single IMP 400 of FIGS. 3A and 3B. Similarly, with reference to FIG. 5B, a plurality of IMPs 400 can be interconnected in parallel and included in place of the single IMP 400 of FIG. 4.

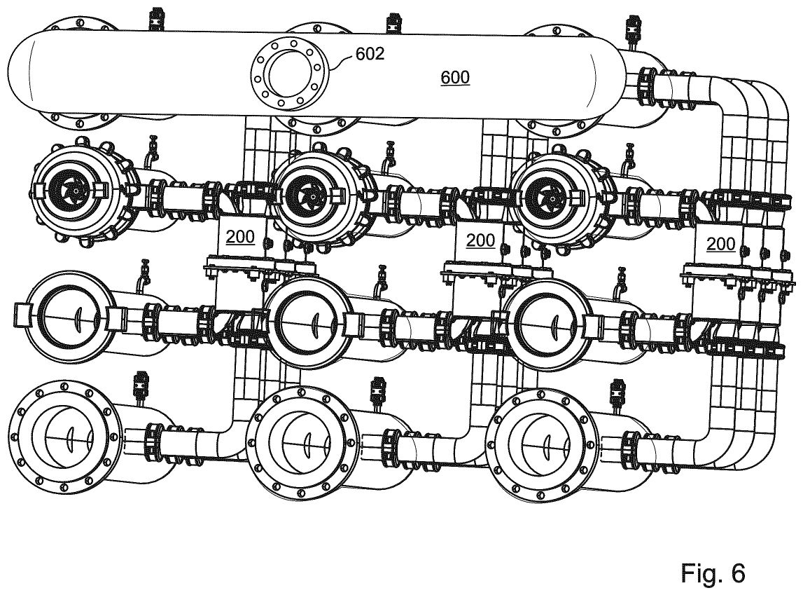

The present invention is modular, and can be manufactured in “standard” sizes and configurations for reduced cost of production. With reference to FIG. 6, if a given installation requires additional energy recovery capacity, a plurality of the disclosed RO energy recovery modules can be installed formation, and interconnected by manifolds 600 extending horizontally perpendicular to each of the four conduits 300, 302, 304, 306. In the embodiment of FIG. 6, each of the energy recovery modules includes three ERDs 400 on only one side of the stack of conduits 300, 302, 304, 306. Only one manifold 600 is shown in the figure for clarity of illustration so that most of the structure of the three energy recovery modules is visible. Each manifold includes a connecting port 602 for interconnection with the remainder of the reverse osmosis installation.

In embodiments, the disclosed module includes sensors and/or controls that are remotely accessible by wired or wireless communication, thereby connecting the module to the “internet of things (IOT), and enabling implementation of features such as smart controls & predictive maintenance and/or analytics.

The foregoing description of the embodiments of the invention has been presented for the purposes of illustration and description. Each and every page of this submission, and all contents thereon, however characterized, identified, or numbered, is considered a substantive part of this application for all purposes, irrespective of form or placement within the application. This specification is not intended to be exhaustive or to limit the invention to the precise form disclosed. Many modifications and variations are possible in light of this disclosure.

Although the present application is shown in a limited number of forms, the scope of the disclosure is not limited to just these forms, but is amenable to various changes and modifications. The present application does not explicitly recite all possible combinations of features that fall within the scope of the disclosure. The features disclosed herein for the various embodiments can generally be interchanged and combined into any combinations that are not self-contradictory without departing from the scope of the disclosure. In particular, the limitations presented in dependent claims below can be combined with their corresponding independent claims in any number and in any order without departing from the scope of this disclosure, unless the dependent claims are logically incompatible with each other.

1: A reverse osmosis (RO) energy recovery module suitable for recovering pressure energy from a membrane osmosis device (MO device), the RO energy recovery module comprising:
an energy recovery device (ERD) configured to transfer pressure from a high-pressure brine output of the MO device to low-pressure water, thereby producing pressurized water, the ERD comprising a high-pressure brine inlet, a pressurized water outlet, a low-pressure water inlet, and a low-pressure brine outlet;
a transverse stack of longitudinal conduits arranged proximate the ERD, the transverse stack of longitudinal conduits comprising a low-pressure water conduit, a pressurized water conduit, a high-pressure brine conduit, and a low-pressure brine conduit, each of the longitudinal conduits being fixed to and in fluid communication with a corresponding one of the ERD inputs and outputs; and
an integral motor pump (IMP) extending from and directly fixed to a longitudinal outlet end of the pressurized water conduit, the IMP being configured to transform pressurized water flowing out from the pressurized water conduit into high-pressure water that is suitable for input into the MO device;
wherein the IMP is directly coupled to the pressurized water conduit and coaxial therewith, the IMP being transversely nested between a first and a second of the longitudinal conduits that are directly adjacent to the pressurized water conduit on either side thereof.

2: The RO energy recovery module of claim 1, wherein the ERD is a first ERD of a plurality of substantially identical ERDS having inputs and outputs that are fixed to and in fluid communication with the longitudinal conduits.

3: The RO energy recovery module of claim 2, wherein the first ERD is located on a first side of the transverse stack of longitudinal conduits, and wherein a second ERD of the plurality of ERDs is located on an opposing, second side of the transverse stack of longitudinal conduits.

4: The RO energy recovery module of claim 1, wherein the ERD comprises a substantially cylindrical transverse body.

5: The RO energy recovery module of claim 4, wherein the ERD further comprises:
a drum that is coaxial with the cylindrical body and rotatable therein; and
first and second ducts fixed within the drum on opposing sides thereof;
rotation of the drum causing the first and second ducts to alternately and concurrently form fluid connections between the high-pressure brine inlet and the pressurized water outlet, and between the low-pressure water inlet and the low-pressure brine outlet, thereby filling the first duct with high-pressure brine while water contained within the first duct is pressurized and forced out of the first duct through the pressurized water outlet, while the second duct is filled with low-pressure water while low-pressure brine contained within the second duct is forced out of the second duct through the low-pressure brine outlet.

6: The RO energy recovery module of claim 1, wherein the IMP is transversely nested between the low-pressure water conduit and the high-pressure brine conduit.

7: The RO energy recovery module of claim 1, wherein the IMP is substantially cylindrical, having a diameter that does not exceed a largest diameter of the longitudinal conduits by more than 25%.

8: The RO energy recovery module of claim 1, wherein the IMP is substantially cylindrical about an IMP axis, the IMP comprising:
an impeller configured to rotate about the IMP axis;
a plurality of permanent magnets fixed to a rear side of the impeller and configured to pass in close axial proximity to a corresponding plurality of stator coil assemblies as the impeller rotates, the permanent magnets and stator coil assemblies in combination forming an integral, axial motor that drives the impeller.

9. (canceled)

10: The RO energy recovery module of claim 1, wherein the IMP comprises a plurality of IMP modules directly interconnected longitudinally and coaxially in series, all of which are transversely nested between the first longitudinal conduit and the second longitudinal conduit.

11: The RO energy recovery module of claim 1, wherein the IMP comprises a plurality of IMP modules interconnected in parallel and extending laterally from the pressurized water conduit between the first longitudinal conduit and the second longitudinal conduit.

12: A reverse osmosis water desalination system (RO system), the RO system comprising:
a low-pressure feed pump configured to direct low pressure water into the RO system;
a membrane osmosis device (MO device) configured to separate high-pressure water into fresh water and high-pressure brine;
a high-pressure feed pump configured to convert a first portion of the low-pressure water into a first portion of the high-pressure water;
an RO energy recovery module according to claim 1, the RO energy recovery module being configured to receive the high-pressure brine, and to convert a second portion of the low-pressure water, into a second portion of the high-pressure water, the combined first and second portions of the high-pressure water being the high-pressure water that is separated by the MO device into the fresh water and the high-pressure brine.

13: The RO system of claim 12, wherein the ERD is a first ERD of a plurality of substantially identical ERDS having inputs and outputs that are fixed to and in fluid communication with the longitudinal conduits.

14: The RO system of claim 13, wherein the first ERD is located on a first side of the transverse stack of longitudinal conduits, and wherein a second ERD of the plurality of ERDs is located on an opposing, second side of the transverse stack of longitudinal conduits.

15: The RO system of claim 12, wherein the IMP is transversely nested between the low-pressure water conduit and the high-pressure brine conduit.

16: The RO system of claim 12, wherein the IMP is substantially cylindrical, having a diameter that does not exceed a largest diameter of the longitudinal conduits by more than 25%.

17: The RO system of claim 12, wherein the IMP is substantially cylindrical about an IMP axis, the IMP comprising:
an impeller configured to rotate about the IMP axis;
a plurality of permanent magnets fixed to a rear side of the impeller and configured to pass in close axial proximity to a corresponding plurality of stator coil assemblies as the impeller rotates, the permanent magnets and stator coil assemblies in combination forming an integral, axial motor that drives the impeller.

18. (canceled)

19: The RO system of claim 12, wherein the IMP comprises a plurality of IMP modules directly interconnected in series, all of which are transversely nested between the first longitudinal conduit and the second longitudinal conduit.

20: The RO system of claim 12, wherein the RO energy recovery module is one of a plurality of substantially identical RO energy recovery modules that are included in the RO system, the RO energy recovery modules being aligned in a longitudinal row, axial inlets of the low-pressure water conduits, axial outlets of the IMPs, axial inlets of the high-pressure brine conduits, and axial outputs of the low-pressure brine conduits being transversely spaced apart and longitudinally aligned and interconnected respectively by a low pressure water manifold, an IMP manifold, a high-pressure brine manifold, and a low pressure brine manifold.

21: The RO energy recovery module of claim 1, wherein the ERD is entirely supported by the longitudinal conduits.

22: The RO system of claim 12, wherein the ERD is entirely supported by the longitudinal conduits.
